(19) United States
(12) Patent Application Publication
(10) Pub. No.: US 2025/0106761 A1
(43) Pub. Date: Mar. 27, 2025

(54) POWER SAVING METHOD AND WIRELESS COMMUNICATION SYSTEM

(71) Applicant: Continental Automotive Technologies GmbH, Hannover (DE)

(72) Inventors: Rikin Shah, Langen (DE); David Gonzalez Gonzalez, Egelsbach (DE); Osvaldo Gonsa, Frankfurt (DE)

(73) Assignee: Continental Automotive Technologies GmbH, Hannover (DE)

(21) Appl. No.: 18/723,694

(22) PCT Filed: Dec. 20, 2022
(86) PCT No.: PCT/EP2022/086882

§ 371 Date: Jun. 24, 2024

(30) Foreign Application Priority Data
Dec. 23, 2021 (DE) 10 2021 214 989.8

(51) Int. Cl. H04W 52/02; H04W 24/08

(52) U.S. Cl. CPC H04W 52/0216; H04W 24/08

(57) ABSTRACT

Power is saved by a user equipment (UE) in a communication system by sending a first message from a user equipment (UE) to a base station (gNB), monitoring a second message from base-station (gNB), starting a response window, monitoring a first mode and a second mode in the second message from base-station (gNB) by the user equipment (UE), whereby the first mode describes a first time period, and the second mode describes a second time period.

### CROSS-REFERENCE TO RELATED APPLICATIONS

The present application is a National Stage Application under 35 U.S.C. § 371 of International Patent Application No. PCT/EP2022/086882 filed on Dec. 20, 2022, and claims priority from German Patent Application No. 10 2021 214 989.8 filed on Dec. 23, 2021, in the German Patent and Trademark Office, the disclosures of which are herein incorporated by reference in their entireties.

### TECHNICAL FIELD

The invention relates into the field of decentralized power saving for user equipment's (UE) and a Wireless Communication System.

### BACKGROUND

Broadcast access to communication media shared by multiple network devices requires organization and control so that each of the network devices has the ability to send data-containing messages over the media. The shared communication medium is characterized by the fact that only one of the network devices is allowed to transmit at any time, while all other network devices can receive, but are not allowed to send. Examples of shared communication media include bus systems to which multiple network devices are directly connected, or frequencies or frequency ranges or channels of wireless communication systems on which multiple network devices communicate with each other. In the case of spatial multiplex on the same frequencies, frequency ranges or channels, e.g. by means of directional antennas, which transmit directed into individual areas or sectors or receive in these areas or sectors, the shared communication medium is the frequency or frequency range or channel used by the network devices within this spatial area or sector.

US2021092777 relates to a method and apparatus for performing random access in a user equipment for a small cell e-NB with a small cell service area in heterogeneous e-NB cell carrier integration (dual connectivity or inter-eNB carrier aggregation) in mobile communication systems. In accordance with an aspect of the present disclosure, a method for performing random access in a mobile communication system is provided. The method includes receiving a configuration request message for configuring a Serving Cell Group (SCG) from a second eNB located in a service area of a first eNB through the first eNB; configuring an SCG cell based on the configuration request message, and sending a configuration response message in response to the configuration request message to the second eNB through the first eNB; and performing random access if there is uplink data present on a logic channel (LCH) relocated into the SCG cell.

WO2021094649 discloses a method performing at least one first monitoring of a power savings channel of a physical downlink control channel (PDCCH) for control information, the PDCCH being associated with at least one base station, the control information including a power saving downlink control information (PS-DCI) format, the control information providing an indication to start a timer for an ON duration of a discontinuous reception (DRX) cycle for a user equipment (UE) to monitor the PDCCH. The method further includes performing a random-access channel (RACH) procedure with the at least one base station based on the control information. The network node performs the method.

US2021014905 discloses is a method of managing random access of a User Equipment, UE, in a telecommunication network, comprising the steps of the UE receiving, from a Base Station, BS, information regarding a response delay interval; the UE transmitting a preamble to a BS; the UE entering a power-saving mode for the duration of the response delay interval, before monitoring for a response from the BS to the preamble.

US2018249508 discloses a random access response (RAR) transmission method and device for ensuring independent transmission of RARs having different coverage enhancement levels, reducing a blind test of a physical downlink control channel performed by a terminal, and saving power consumption of the terminal. This application provides an RAR transmission method, comprising: determining, by a network side and at least according to coverage enhancement levels corresponding to physical downlink control channels, frequency domain resources of the physical downlink control channels, wherein the frequency domain resources of the physical downlink control channels having different coverage enhancement levels are independently configured; and transmitting, by the network side, the physical downlink control channels on the frequency domain resources of the physical downlink control channels.

According to current MAC specification, after transmitting the Random Access Preamble, the user equipment (UE) monitors the PDCCH for the Random Access Response (RAR) message. The user equipment (UE) starts response window, also called monitor window, (ra-Response Window) at a determined time interval after the preamble transmission that is mentioned in 38.321 v16.3.0 section 5.

All user equipment (UE) apply common value of the monitor window (ra-Response Window) through system information. The value of ra-Response Window is up to 80 slots as mentioned in 38.331 v16.3.0 section 6.3.2. For an example, if base-station (gNB) configures ra-Response Window sl40 which means base-station (gNB) can send RAR within 40 slots after receiving random access preamble. Therefore, user equipment (UE) may need to monitor RAR for maximally 40 slots after sending random access preamble.

With the known methods for controlling to reduce power consumption conflict transmissions of information can't be avoided as the devices and/or user equipment (UE) will continue the unnecessarily transmission. This means that the reduction of power consumption is still very low and not used in the best possible way. This can be described as follows. After sending Msg1, user equipment (UE) wakes up entirely during the monitoring time period of Random Access Response (RAR). However, this could result in unnecessary user equipment (UE) power consumption particular for Small Data Transmission for user equipment (UE) in the following scenario. User equipment (UE) may not be scheduled immediately after sending Random Access Preamble but still keeps monitoring Random Access Response during the entire monitoring period as shown in FIG. 1 Monitoring Window for Random Access Response, assuming Basestation (gNB) prioritizes the scheduling of Random Access Response based on the traffic load. As a result, the user equipment (UE) consumes power in monitoring RAR during the period when base station (gNB) doesn't intend to schedule anything to the UE.

Based on this, the present invention has the object of creating a decentralized method to reduce power consumption especially for Small Data Transmission and a network device and 7Or user equipment (UE) set up to carry out the method in order to overcome or at least improve one or more of the problems mentioned above.

Especially a user equipment (UE) having the first mode describing a first time period and the second mode describing a second time period. is is able to implement the functionality with a first mode and a second mode, which defines an active period and the inactive period. This might also be named “ON-OFF duration” in the Random Access Response monitoring window, when it monitors Random Access Response from the base-station (gNB) as shown in FIG. 2.

To solve this problem, embodiments of the invention propose a power saving method to reduce power consumption for user equipment (UE), which is used in each of the network devices/user equipments (UE). In addition, embodiments of the invention propose a network device/user equipment (UE) which is set up to carry out the method.

### BRIEF SUMMARY

An embodiment of the power saving method performed by a user equipment (UE) in communication system is characterized by sending a fist message form a user equipment (UE) to a base station (gNB), monitoring a second message from base-station (gNB), starting monitoring window, monitoring a first mode and a second mode in the second message from base-station (gNB) by the user equipment (UE), whereby the first mode describes a first time period and the second mode describes a second time period.

A further embodiment of the method characterized by, that the first time period defines an active-time-period and the second time period defines an inactive-time-period

A further embodiment of the method is characterized by when second time period expires, the user equipment (UE) starts the first time period.

A further embodiment of the method characterized by, that the user equipment (UE) receives from the base-station (gNB) a transmitted information message indicating the user equipment (UE) to start a time period, whereby one bit digit is used to indicate whether to start the first time period.

An embodiment of the method is characterized by, that if the one bit digit is set to “0” it indicates to start the first time period and if the one bit digit is set to “1” it indicates to start the second time period.

A further embodiment of the method is characterized by, that, the transmitted information message indicating the user equipment (UE) to start the first time period, user equipment (UE) extends the first time period.

A further embodiment of the method is characterized by, that, the transmitted information message indicating the user equipment (UE) to start the first time period, user equipment (UE) extends the first time period based on the time indicated in the transmitted information message.

A further embodiment of the method is characterized by that the transmitted information message indicating the user equipment (UE) to start the first time period is used by the user equipment (UE) in order to cancel the next second time period.

A further embodiment of the method is characterized by, that the transmitted information message indicating the user equipment (UE) to start the active-time-period.

A further embodiment is characterized by a base-station (gNB) in communication system, base-station (gNB) extends the first time period dynamically by considering the current traffic load situation and base-station (gNB) sends indication through a transmitted information system.

A further embodiment is an apparatus to reduce power consumption for Small Data Transmission by a base station (gnB) in a wireless communication system, the apparatus comprising a wireless transceiver, a processor coupled with a memory in which computer program instructions are stored, said instructions being configured to implement steps of the claims 10.

A further embodiment is a user Equipment (UE) comprising an apparatus according to claim 11.

A further embodiment is a base station (gNB) comprising an apparatus according to claim 12.

A further embodiment is a wireless communication system for reducing Small Data Transmission from a base station (gNB) to a user equipment (UE), wherein the base station comprises a processor coupled with a memory in which computer program instructions are stored, said instructions being configured to implement steps of claim 10, wherein the user equipment (UE) comprises a processor coupled with a memory in which computer program instructions are stored, said instructions being configured to implement steps of the claims 1 to 9.

Computer program product, comprising commands which, when executed by a computer, cause it to execute the method according to one or more of claims 1-10 is one preferred embodiment of the invention.

Computer-readable data carrier on which the computer program product according to claim 16 is stored is one further preferred embodiment of the invention.

A further embodiment of the method is characterized by the introduction of the first mode describes a first time period and the second mode describes a second time period (ON-OFF duration) within Random Access Response (RAR) monitoring the wake up time of the user equipment (UE) is reduced.

A further embodiment of the method is characterized by the wake up time of the user equipment (UE) is the active time of the user equipment (UE).

A further embodiment of the method is characterized by when the OFF-duration expires the user equipment (UE) starts the ON-duration, whereby when ON-Duration is running the user equipment (UE) stays awake and monitors Random Access Response (RAR), and when the ON-Duration expires the user equipment (UE) starts the OFF-Duration, whereby when OFF-Duration is running the user equipment (UE) stops monitoring Random Access Response (RAR),

A further embodiment of the method is characterized by that the base-Station (gNB) starts triggering the start of the ON-duration or the OFF-Duration by transmitting a system information message to the user equipment (UE), whereby 1 bit digit is used to indicate whether to start first ON-Duration or OFF-Duration

A further embodiment of the method is characterized if the 1 bit digit is set to “0” it indicates to start the ON-Duration and if the 1 bit digit is set to “1” it indicates to start the OFF-Duration.

A further embodiment of the method is characterized by upon receiving Medium Access Control Control Element (MAC CE) or Physical downlink control channel (PDCCH) from the base-station (gNB), user equipment (UE) extends the ON Duration to monitor Random Access Response (RAR) message.

A further embodiment of the method is characterized by upon receiving Medium Access Control Control Element (MAC CE) or Physical downlink control channel (PDCCH) from the base-station (gNB), user equipment (UE) extends the ON Duration to monitor Random Access Response (RAR) message based on the time indicated in Medium Access Control Control Element (MAC CE) or Physical downlink control channel (PDCCH).

A further embodiment of the method is characterized by upon receiving Medium Access Control Control Element (MAC CE) or Physical downlink control channel (PDCCH) from the base-station (gNB), user equipment (UE) cancels next OFF-Duration.

A further embodiment of the method is characterized by upon receiving Medium Access Control Control Element (MAC CE) or Physical downlink control channel (PDCCH) from the base-station (gNB), user equipment (UE) restarts ON-Duration.

One embodiment of the method to reduce power consumption for Small Data Transmission performed by a base-station (gNB) in a wireless communication system, is characterized by, that the base-station (gNB) extends ON duration dynamically by considering the current traffic load situation and base-station (gNB) sends indication through Medium Access Control Control Element (MAC CE) or Physical downlink control channel (PDCCH) or Radio Resource Control (RRC) protocol.

A further embodiment is an apparatus to reduce power consumption for Small Data Transmission by a user equipment (UE) in a wireless communication system, the apparatus comprising a wireless transceiver, a processor coupled with a memory in which computer program instructions are stored, said instructions being configured to implement steps of the claims 1 to 9

Further, the invention proposes a computer program with computer program instructions that implement the method when executed on a computer with a communication interface. In addition, the invention proposes a computer program product that provides computer-readable signals which, when read by a computer, provide a computer program according to the third aspect. The computer-readable signals can be provided on a physically embodied data carrier or in a carrier signal.

Generally spoken the 3GPP NR radio access deployment includes a base station (gNB) having transmission and reception points (TRPs). Each TRP may be, for example, a remote radio head (RRH) or remote radio unit (RRU) including at least, for example, a radio frequency (RF) antenna (or antennas) or antenna panels, and a radio transceiver, for transmitting and receiving data within a geographical area. In this regard, the TRPs provide cellular resources for user equipment (UEs) within a geographical coverage area. In some cases, baseband processing may be divided between the TRPs and gNB in a 5th Generation (5G) cell. Alternatively, the baseband processing may be performed at the gNB. The TRPs are configured to communicate with a UE via one or more transmit (TX)/receive (RX) beam pairs. The gNB communicates with the core network, which is referred to as the New Core in 3 GPP NR. The TRPs may have independent schedulers, or the gNB may perform joint scheduling among the TRPs. It is clear that the gNB and TRPs may provide communication services to a relatively large number of UEs within the coverage area of the TRPs.

The gNB includes a memory; a processor connected to the memory; various interfaces connected to the processor and one or more antennas or antenna panels connected to the various interfaces. The various interfaces and the antenna may constitute a transceiver for transmitting/receiving data from/to the gNB via a plurality of wireless beams or from/to the plurality of TRPs, etc. Depending on the implementation and configuration of the gNB, within the gNB many more components may be included.

The memory may be a computer readable storage medium that generally includes a random access memory (RAM), read only memory (ROM), and/or a permanent mass storage device, such as a disk drive. The memory also stores an operating system and any other routines/modules/applications for providing the functionalities of the gNB e.g., functionalities of a gNB, methods according to the example embodiments, etc. to be executed by the processor. These software components may also be loaded from a separate computer readable storage medium into the memory using a drive mechanism. Such separate computer readable storage medium may include a disc, tape, DVD/CD-ROM drive, memory card, or other like computer readable storage medium. In some example embodiments, software components may be loaded into the memory via one of the various interfaces, rather than via a computer readable storage medium.

The processor may be configured to carry out instructions of a computer program by performing the arithmetical, logical, and input/output operations of the system. Instructions may be provided to the processor by the memory. The various interfaces may include components that interface the processor with the antenna, or other input/output components. As will be understood, the various interfaces and programs stored in the memory to set forth the special purpose functionalities of the gNB will vary depending on the implementation of the gNB. The interfaces may also include one or more user input devices (e.g., a keyboard, a keypad, a mouse, or the like) and user output devices (e.g., a display, a speaker, or the like). The memory may store an operating system and any other routines/modules/applications for providing the functionalities of the TRPs, etc. e.g., functionalities of these elements, methods according to the example embodiments, etc. to be executed by the processor.

The UE is a device used by an end-user to communicate via the 3 GPP NR radio access deployment. Examples of UEs include cellular phones, smartphones, tablet, computers, laptop computers, or the like.

The UE includes a memory, a processor connected to the memory; various interfaces connected to the processor; and one or more antennas or antenna panels connected to the various interfaces. The various interfaces and the antenna may constitute a transceiver for transmitting/receiving data to/from the gNB via a plurality of wireless beams or to/from the plurality of TRPs. Depending on the implementation of the UE, the UE may include many more components.

The memory may be a computer readable storage medium that generally includes a random access memory (RAM), read only memory (ROM), and/or a permanent mass storage device, such as a disk drive. The memory also stores an operating system and any other routines/modules/applications for providing the functionalities of the UE e.g., functionalities of a UE, methods according to the example embodiments, etc. to be executed by the processor. These software components may also be loaded from a separate computer readable storage medium into the memory using a drive mechanism. Such separate computer readable storage medium may include a disc, tape, DVD/CD-ROM drive, memory card, or other like computer readable storage medium. In some example embodiments, software components may be loaded into the memory via one of the various interfaces of the UE, like WLAN Access, Bluetooth Connection, etc., rather than via a computer readable storage medium. The processor of the UE may be configured to carry out instructions of a computer program by performing the arithmetical, logical, and input/output operations of the system. Instructions may be provided to the processor by the memory.

The various interfaces may include components that interface the processor with the antenna, or other input/output components. As will be understood, the various interfaces and programs stored in the memory to set forth the special purpose functionalities of the UE will vary depending on the implementation of the UE. The interfaces may also include one or more user input devices (e.g., a keyboard, a keypad, a mouse, or the like) and user output devices (e.g., a display, a speaker, or the like).

The following description assumes that each of the UEs can receive messages from all other network devices. For this purpose, the network devices may be located at a distance that allows direct communication with each other, but it is also possible to route the communication of the network devices via one or more transmit/receiver units acting as repeaters, so that a group exists even if not all network devices can communicate directly with all other network devices in the group. The repeaters can also be connected to each other via another network by type of access point. Receiving messages from other network devices is also referred to as “listening” or “monitoring” in the following description.

Every network device/user equipment (UE) has a unique identifier or identification assigned to it, e.g. a MAC address. In addition, each network device or user equipment (UE) has at least one interface set up for bidirectional communication.

A user equipment (UE) is configured with “ON-OFF duration” in the RAR monitoring window, when it monitors RAR message (MSg2) from the base-station (gNB)

Beneficially introducing such “ON-OFF duration” within RAR monitoring window can reduce UE's wake up time (i.e., active time) to monitor RAR from gNB which reduces UE's power consumption, like is illustrated in FIG. 2.

The user equipment (UE) may be set up for the use of certain frequencies or frequency bands or channels, but the use of the proposed method is independent and can be applied independently of the used operating bandwidths.

The interface and the user equipment (UE) behaviors during “ON-OFF duration”, in such a manner that when “OFF duration” expires, UE starts “ON duration”, and when “ON duration” is running, the UE stays awake and monitors RAR. Furthermore when “ON duration” expires, UE starts “OFF duration”, when “OFF duration” is running, the UE doesn't need to monitor RAR.

Whether to start first “ON duration” or “OFF duration” is informed by gNB through system information message, 1 bit is used to indicates whether to start first “ON duration” or “OFF duration, whereby “0” indicates to start “ON duration” first and “1” indicates to start “OFF duration” first.

Each of the UEs/network devices may have a timer that runs synchronously across all of the network devices. The timer can be a synchronizable timer, or a sufficiently accurate time source available to all network devices, i.e. a time signal of a satellite navigation system, or time signals of a time signal transmitter for radio-controlled clocks, e.g. DCF77, MSF, WWV, WWV, WWVB, WWVH or the like.

### BRIEF DESCRIPTION OF THE DRAWING

In the following, embodiments of the invention are explained in more detail with reference to the accompanying figures. All figures are purely schematic and not scaled.

FIG. 1 depicts a Monitoring Window for Random Access Response.

FIG. 2 depicts a Random Access Response Monitoring Windows with ON-OFF Duration.

FIG. 3 depicts Extending “Active” to monitor RAR message.

FIG. 4 depicts UE extending its “Active” based on the time indicated in MAC CE or PDCCH by a TimeX.

FIG. 5 depicts the UE extending Active.

FIG. 6 depicts UE restarting “Active”.

FIG. 7 depicts an example of the user equipment behavior.

FIGS. 8a-f depict the RAR Monitoring Windows in comparison between the current approach and the proposed new approaches.

FIG. 9a depicts an example with 3 sub-windows with no shift.

FIG. 9b depicts an example with 3 sub-windows with shift.

FIG. 10a depicts an example with 4 sub-windows with no shift.

FIG. 10b depicts an example with 4 sub-windows with shift.

### DETAILED DESCRIPTION

The same or similar elements are provided with the same or similar reference signs in the figures. Generally spoken used term first mode and second mode is used can be generally used as an active-time period and an inactive-time-period. These time periods are represented in the figures and the following discussion as Active (ON-Duration) and Inactive (Off-Duration).

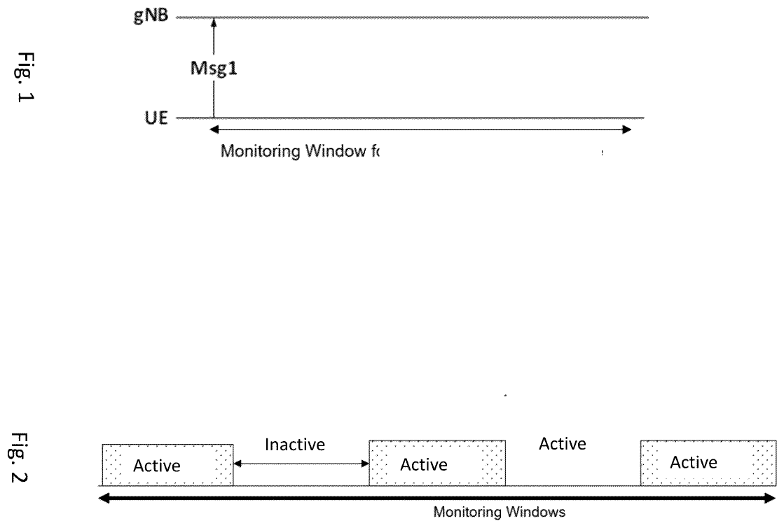

FIG. 1 shows the Monitoring Window for Random Access Response between a user equipment (UE) and and base-station (gNB).

Once a user equipment (UE) has transmitted a random-access preamble (Msg1), it waits for a random-access response, that is, a response from the network that it has properly received the preamble. The random-access response may be transmitted as a conventional downlink PDCCH/PDSCH transmission with the corresponding PDCCH transmitted within the common search space.

The random-access response includes the following;
The index of the random-access preamble the network detected and for which the response is valid;
A timing correction calculated by the network based on the preamble receive timing. The device should update the uplink transmission timing according to the correction before further uplink transmissions;
A scheduling grant, indicating what resource the device should use for the transmission of the subsequent message 3 (see below);
A temporary identity, the TC-RNTI, used for further communication between the device and the network.

If the network detects multiple random-access attempts (from different devices), the individual response messages can be combined in a single transmission. Therefore, the response message is scheduled on the DL-SCH and indicated on a PDCCH using an identity reserved for random-access response, the RA-RNTI. The use of the RA-RNTI is also necessary as a device may not have a unique identity in the form of a C-RNTI allocated. All devices that have transmitted a preamble monitor the L1/L2 control channels for random-access response within a configurable time window. The timing of the response message is not fixed in the specification in order to be able to respond to many simultaneous accesses. It also provides some flexibility in the base-station implementation. If the device does not detect a random-access response within the time window, the preamble will be retransmitted with higher power according to the preamble power ramping described above.

As long as the devices that performed random access in the same resource used different preambles, no collision will occur and from the downlink signaling it is clear to which device(s) the information is related. However, there is a certain probability of contention—that is, multiple devices using the same random-access preamble at the same time. In this case, multiple devices will react upon the same downlink response message and a collision occurs. Resolving these collisions is part of the subsequent steps, as discussed below.

Upon reception of the random-access response, the device will adjust its uplink transmission timing and continue to the third step. If contention-free random access using a dedicated preamble is used, then this is the last step of the random-access procedure as there is no need to handle contention in this case. Furthermore, the device already has a unique identity allocated in the form of a C-RNTI.

In the case of downlink beamforming, the random-access response should follow the beamforming used for the SS block, which was acquired during the initial cell search. This is important as the device may use receive-side beamforming and it needs to know how to direct the receiver beam. By transmitting the random-access response using the same beam as the SS block, the device knows that it can use the same receiver beam as identified during the cell search.

FIG. 2 shows the Monitoring Windows with included Active-Inactive Duration.

FIG. 2 shows a schematic flowchart of power saving method to reduce power consumption. A user equipment (UE) is configured with a first mode describing a first time period and the second mode describing a second time period, representing the such as the “Active-Inactive duration” in the monitoring window, when it monitors message (MSg2) from the base-station (gNB). An advantage of that approach is introducing such “Active-Inactive duration” within monitoring window reduces UE's wake up time (i.e., active time) to monitor RAR from base-station (gNB) which reduces UE's power consumption.

FIG. 2 shows an exemplary message flowchart of the method according to the invention. The interface and the user equipment (UE) behaviors during “Active-Inactive” duration”, in such a manner that when “Inactive duration” expires, UE starts “Active duration”, when “Active duration” is running, the UE stays awake and monitor RAR. Furthermore when “Active duration” expires, UE starts “Inactive duration”, when “Inactive duration” is running, the UE doesn't need to monitor RAR.

Whether to start first “Active duration” or “Inactive duration” is informed by base-station (gNB) through system information message, 1 bit is used to indicates whether to start first “Active duration” or “Inactive duration, whereby “0” indicates to start “Active duration” first and “1” indicates to start “Inactive duration” first.

The base station (gNB) can also change value of “Active-Inactive duration” depending on overall load situation, when traffic loads are particularly heavy, gNB can configure longer “Active duration”. This beneficially increases base-station (gNB) scheduling flexibility, but a disadvantage could be an increasing UE power consumption due to longer “Active-Duration”. When traffic loads are less, base-station (gNB) can configure longer “Inactive duration” this reduces UE power consumption due to smaller “Active duration”.

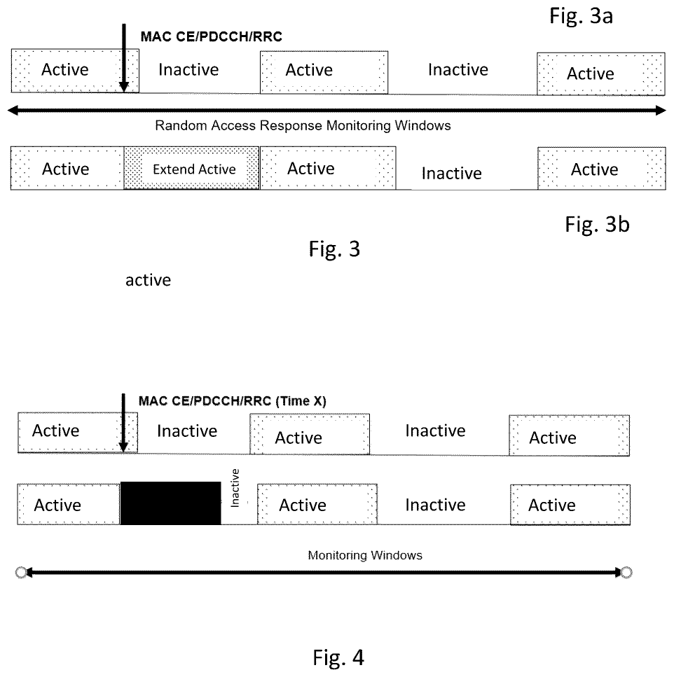

FIG. 3 shows an exemplary message flowchart of the method according to the invention. The interface and the user equipment (UE) behaviors after receiving during an Active-Duration”, in such a manner that it extends “Active Duration” to monitor RAR message till the next ON-Duration, as it can be seen in FIG. 3 visualized by the block (Extend Active Duration).

FIG. 4 shows an exemplary message flowchart of the method according to the invention. The interface and the user equipment (UE) behaviors after receiving during an Active-Duration”, in such a manner that it UE extends its “Active-Dduration” based on the time indicated in MAC CE or PDCCH by a TimeX, as it can be seen in FIG. 4 visualized by the block (Extend ON Duration by TimeX). It is to mention that the TimeX has such a dimension that it is lower the OFF-Duration, so if the TimeX is used a short Inactive-Duration block remains before the next ON-Duration starts, as it can been seen in the FIG. 4.

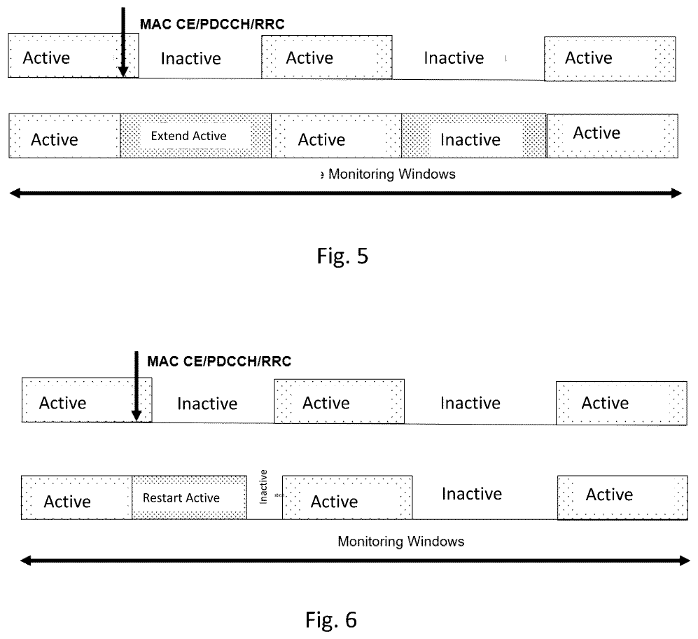

FIG. 5 shows an exemplary message flowchart of the method according to the invention. The interface and the user equipment (UE) behaviors after receiving during Active-Duration”, in such a manner that it extends “Active-Duration” to monitor RAR message till the next Active-Duration, as it can be seen in FIG. 5 visualized by the block (Extend Active Duration).

FIG. 6 shows an exemplary message flowchart of the method according to the invention. The interface and the user equipment (UE) behaviors after receiving during an Active-Duration”, in such a manner that it restarts in the current “Active-Duration” block to monitor RAR message. The restart is dimensioned that the restart block has the same dimension like Active-Duration block, as it can be seen in FIG. 6 visualized by the block (Restart Active-Duration). After the restart block has been ended thre will be a OFF-Duration.

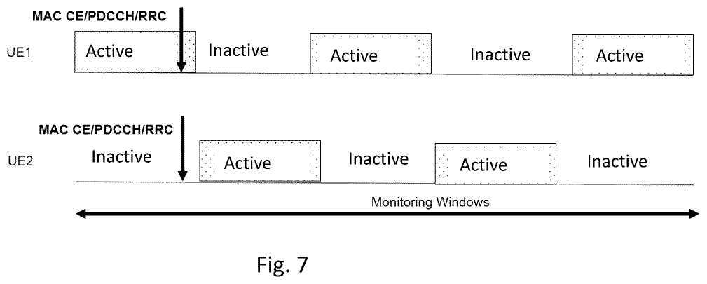

FIG. 7 shows an example of the user equipment behavior. When gNB sends MAC CE, it could possible where one UE is on-duration Time and second UE is in OFF duration time. There is a possibility where different UEs “On duration” could be different among UEs as shown in figure. In such case, UE1 will extend its “on duration” upon received MAC CE. On the other side UE2 will miss MAC CE due to its “OFF duration”. In this case, UE2 will monitor response to the next On-duration without extending its on duration time. Furthermore, gNB is aware the ON duration period and OFF duration period based on the preamble received from UEs. In short, one “MAC CE” is associated with PRACH time instance.

FIG. 8a shows the overall overview about the Monitoring Windows.

FIG. 8b depicts the new proposal, that after US sending Msg1 the Active-Inactive Duration is established on UE side.

FIG. 8c depicts gNB sends MAC CE/PDCCH to extend UE's Active-Duration.

FIG. 8d depicts UE extends “Active-Duration” by skipping next “Inactive-Duration.

FIG. 8e depicts UE extends “Active-Duration” by Time indicated in MACE CE/PDCCH or restarts “Active-Duration.

FIG. 8f depicts UE extends “Active-Duration” by skipping all next Inactive-Duration.

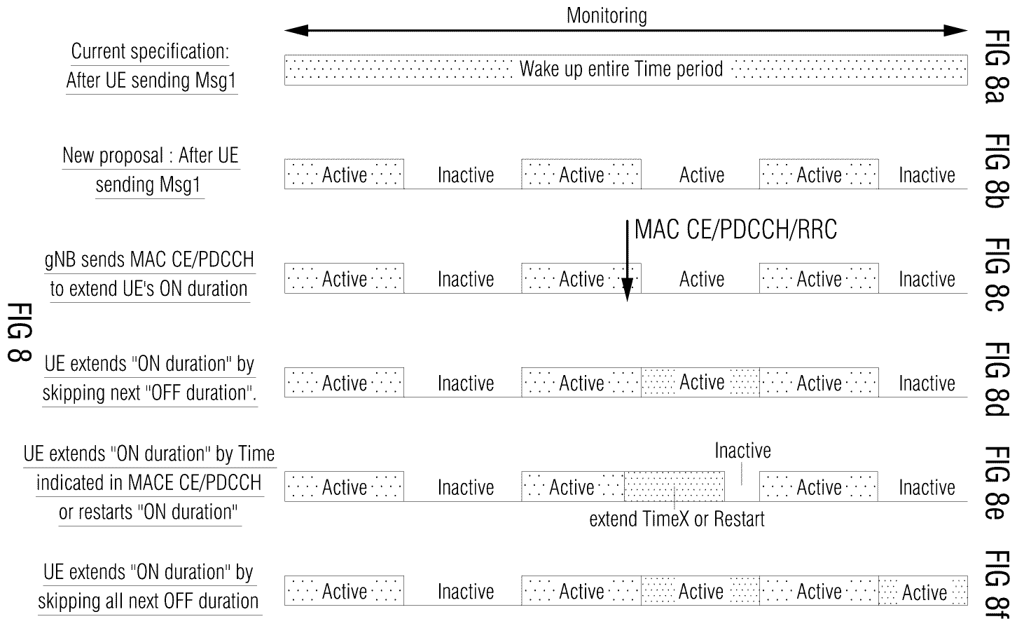

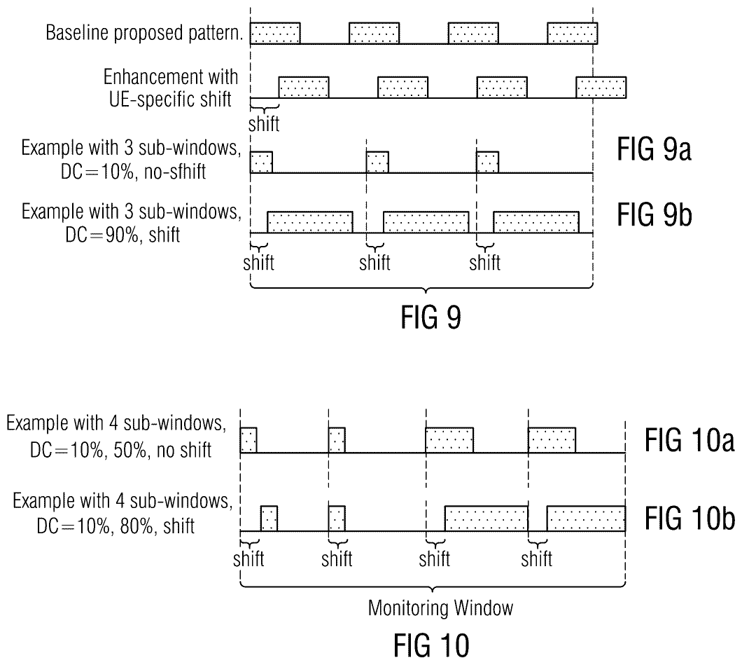

FIG. 9 is a variation of the proposed method named Pattern-based Variable Duty Cycle (DC) with an example with 3 sub-windows with no shift. This is a further variation of the method is that a UE-specific shift, e.g., using a S=mod(ID_{CORESET},X) type of operation where X is a configurable parameter and S is the resulting UE-specific delay. FIG. 9 illustrates as baseline proposed pattern and the enhancement with UE-specific shift. Furthermore, an example with 3 sub-windows, DC=10%, with no-shift and an example with 3 sub-windows DC=90% with shift is shown.

In FIG. 10 an example with 4 sub-windows, DC=10%, 50%, with no-shift and an example with 4 sub-windows DC=10, 80% with shift is shown.

Duty-cycle patterns can be predefined and stored in table containing, at least, sub-windows of the RAR monitoring window and associated duty cycle.

An alternative and variation of the proposed to the UE is configured with multiple ra-Response Window. A UE is configured with multiple ra-Response Window whereby ra-ResponseWindow is associated with different type of UEs. UE with higher power saving can be configured as a smaller ra-ResponseWindow. For example, SDT UE is configured with smaller ra-Response Window than non-SDT UE. gNB configures multiple ra-Response Window based on the UE types through system information message. As an example, UE types can be SDT UE, IoT UE, NTN UE, RedCap UE or non-SDT UE. gNB configures individual ra-ResponseWindow to each type of UE.

This idea can also be combined with main Idea where gNB configures “ON-OFF” duration within ra-Response Window. The configuration of “ON-OFF” duration is different for different types of UE and can be configured depending on the size of ra-Response Window

One benefit is that multiple ra-Response Window allows gNB to configure smaller ra-Response Window for SDT UE. UE can reduce wake up time (i.e., active time) to monitor RAR from gNB which reduces power consumption.

Although the method according to the invention has been described above with reference to wirelessly networked network devices, it is also possible to use the method in a network device connected by a wired bus, for example in a vehicle. In the case of wired networked network devices, a dynamic change in configuration, which is also covered by the procedure, is rather unlikely, but not excluded. For example, network devices could be connected to each other via the bus, which independently switch between active and inactive modes and do not monitor communication in inactive mode in order to save energy.

An application of the method described herein is not limited to vehicles or generally mobile network devices, but it can be used in all cases in which network devices temporarily organize themselves in changing groups, i.e., in smartfactories or the like.

A beneficial User Equipment (UE) is configured with multiple ra-Response Window whereby ra-Response Window is associated with different type of UEs. The UE with higher power saving can be configured as a smaller ra-Response Window. For example, SDT UE is configured with smaller ra-ResponseWindow than non-SDT UE. The basestation (gNB) configures multiple ra-ResponseWindow based on the UE types through system information message. As an example, UE types can be SDT UE, IoT UE, NTN UE, RedCap UE or non-SDT UE. gNB configures individual ra-ResponseWindow to each type of UE.

This method can also be combined with main Idea where gNB configures “ON-OFF” duration within ra-Response Window. The configuration of “ON-OFF” duration is different for different types of UE and can be configured depending on the size of ra-Response Window the benefit of that approach is a_Multiple ra-ResponseWindow allows gNB to configure smaller ra-Response Window for SDT UE. UE can reduce wake up time (i.e., active time) to monitor RAR from gNB which reduces power consumption.

This invention is primary focusing on Small Data Transmission WI. However, it could also apply to other WIs like URLLC, NTN, eMBB, IIoT, IoT, NTN-IoT, Redcap UE and NR-U where power saving is desirable.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc. The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, user equipment, base stations, eNBs, RRHs, gNBs, femto base stations, network controllers, computers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

The benefit of this application is, that introducing the active time periods and inactive time periods the continued monitoring by the user equipment (UE) is intentionally reduced and the consumption and the load of the energy source like the battery is reduced significantly.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1. A power-saving method performed by a user equipment (UE) in a communication system,
the method comprising:
sending a fist message from a user equipment (UE) to a base station (gNB);
monitoring a second message from the base-station (gNB);
starting a monitor window;
monitoring a first mode and a second mode in the second message from the base-station (gNB) by the user equipment (UE);
whereby the first mode describes a first time period, and the second mode describes a second time period.

2. The method according to claim 1, wherein the first time period defines an active-time-period, and the second time period defines an inactive-time-period.

3. The method according to claim 1, wherein when the second time period expires, the user equipment (UE) starts the first time period.

4. The method according to claim 1, wherein the user equipment (UE) receives from the base-station (gNB) a transmitted information message indicating the user equipment (UE) to start the time period, whereby a one-bit digit is used to indicate whether to start the first time period.

5. The method according to claim 4, wherein, if the one-bit digit is set to “0,” it indicates to start the first time period, and, if the one-bit digit is set to “1,” it indicates to start the second time period.

6. The method according to claim 4, wherein the transmitted information message indicating the user equipment (UE) to start the first time period, user equipment (UE) extends the first time period.

7. The method according to claim 4, wherein the transmitted information message indicating the user equipment (UE) to start the first time period, user equipment (UE) extends the first time period based on the time indicated in the transmitted information message.

8. The method according to claim 4, wherein the transmitted information message indicating the user equipment (UE) to start the first time period, the user equipment (UE) cancels the next second time period.

9. The method according to claim 4, wherein the transmitted information message indicating the user equipment (UE) to start the active-time-period.

10. (canceled)

11. An apparatus to reduce power consumption for Small Data Transmission by a user equipment (UE) in a wireless communication system, the apparatus comprising a wireless transceiver, a processor coupled with a memory in which computer program instructions are stored, said instructions being configured to, when executed by the user-equipment processor, cause performance of operations comprising:
sending a first message from the user equipment (UE) to a base station (gNB);
monitoring a second message from the base-station (gNB);
starting a monitor window;
monitoring a first mode and a second mode in the second message from the base-station (gNB) by the user equipment (UE);
whereby the first mode describes a first time period, and the second mode describes a second time period.

12. An apparatus to reduce power consumption for Small Data Transmission by a base station (gnB) in a wireless communication system, the apparatus comprising a wireless transceiver, a processor coupled with a memory in which computer program instructions are stored, said instructions being configured to, when executed by the processor, cause the base station (gnB) to save power by performing operations comprising:
extending a first time period dynamically by considering a current traffic load situation; and
sending indication through a transmitted information system.

13. (canceled)

14. (canceled)

15. (canceled)

16. (canceled)

17. (canceled)

18. The apparatus according to claim 11, wherein the first time period defines an active-time-period, and the second time period defines an inactive-time-period.

19. The apparatus according to claim 11, wherein when the second time period expires, the user equipment (UE) starts the first time period.

20. The apparatus according to claim 11, wherein the user equipment (UE) receives from the base-station (gNB) a transmitted information message indicating the user equipment (UE) to start the time period, whereby a one-bit digit is used to indicate whether to start the first time period.

21. The apparatus according to claim 20, wherein, if the one-bit digit is set to “0,” it indicates to start the first time period, and, if the one-bit digit is set to “1,” it indicates to start the second time period.

22. The apparatus according to claim 20, wherein the transmitted information message indicating the user equipment (UE) to start the first time period, user equipment (UE) extends the first time period.

23. The apparatus according to claim 20, wherein the transmitted information message indicating the user equipment (UE) to start the first time period, user equipment (UE) extends the first time period based on the time indicated in the transmitted information message.

24. The apparatus according to claim 20, wherein the transmitted information message indicating the user equipment (UE) to start the first time period, the user equipment (UE) cancels the next second time period.

25. The method according to claim 20, wherein the transmitted information message indicating the user equipment (UE) to start the active-time-period.
